(19) United States
(12) Patent Application Publication
(10) Pub. No.: US 2019/0065619 A1
(43) Pub. Date: Feb. 28, 2019

(54) SCALABLE SERVER-SIDE RENDERING

(71) Applicant: Coursera, Inc., Mountain View, CA (US)

(72) Inventors: Vishal Fu-Sheng Kuo, Ontario (CA); Bryan Seth Kane, San Francisco, CA (US); Lewis Fulei Chung, San Francisco, CA (US); Jonathan Jing-Ning Wong, San Francisco, CA (US)

(21) Appl. No.: 16/112,445

(22) Filed: Aug. 24, 2018

Related U.S. Application Data
(60) Provisional application No. 62/549,924, filed on Aug. 24, 2017.

(51) Int. Cl. G06F 17/30; G06F 8/71

(52) U.S. Cl. CPC G06F 17/30905; G06F 17/30902; G06F 17/30887; G06F 8/71

(57) ABSTRACT

An online system generates a set of container images that are each stand-alone executable software packages for a corresponding subset of applications of the online system. Responsive to a client request, the software in a container image can be deployed in a container instance to generate rendering information for the subset of applications associated with the container image. The rendering information includes information on the code that can be parsed by the client device to generate a set of display elements of the application. The online system receives a client request to display elements of an application of the online system. The online system routes the request to a container deployment system that contains the set of container images. The container deployment system provides the rendering information to the online system, and the online system forwards the rendering information to the client device.

### CROSS-REFERENCE TO RELATED APPLICATIONS

This application claims the benefit of U.S. Provisional Application No. 62/549,924, filed Aug. 24, 2017, which is hereby incorporated by reference in its entirety.

### BACKGROUND

This invention relates generally to application rendering, and particularly to scalable application rendering using container instances.

Online systems, such as e-commerce websites, online education systems, news providers, and email providers, deploy one or more applications for providing online services to users. For example, an online education system may include a user dashboard page that allows a user to provide log-in information for the user's account, and displays lectures or courses that the user has most recently accessed. An application, in most cases, includes various display elements (e.g., user interface elements) that are displayed on one or more pages in the client device, such that a user can interact with or view other types of information related to the application.

Generally, a page that the display elements reside on can be represented as code in standard markup language (e.g., HTML) including content, components (e.g., JavaScript) for programming additional dynamic elements, and presentation information specifying how the display elements are arranged (e.g., layout, color) on the page. Given such code, a browser application can “render” the code to display the corresponding elements on a page. Responsive to receiving a request for an application, the online system generates and provides rendering information to the client device that contains information on the code that may include the actual content of the code, or components that can generate parts of the code when downloaded to the client device. The client device can then process the rendering information and the code obtained from the rendering information to display the elements of the application.

The online system may execute one or more processes on a computing host that are each responsible for and capable of generating rendering information for any web application responsive to a client request. However, this requires each process in the host to have access to resources for rendering each application, and a significant number of such processes can result in an inefficient use of resources and create system failures such as out-of-memory errors in the host. Moreover, such a system does not account for differences in client request volumes across different applications and lack scalability at the application level.

### SUMMARY

An online system generates a set of container images that are each stand-alone executable software packages of a corresponding subset of applications of the online system. An application may be a client-server software program directed to some functionality, task, or service of the online system, in which the interface is run on a client device. For example, different applications within an online education system may allow a user to register for an account, pay for access to course materials for a specific online course, and guide the user through the course materials of the online course. An application usually includes a set of display elements that are presented on one or more pages of the client device.

Responsive to a client request, the software in a container image can be deployed in a container instance to generate rendering information for the subset of applications associated with the container image. The rendering information is processed by the client device to obtain code that can be parsed and interpreted by the client device to present the display elements of the applications on one or more pages of the client device. In one embodiment, the rendering information is code that already includes content of the application response (“server-side rendering”).

Specifically, the online system receives a client request to display elements of an application of the online system. The online system routes the request to a container deployment system that contains the set of container images. The container deployment system receives the request and identifies the appropriate container image associated with the application of the request. The container deployment system deploys the software of the selected container image in a container, and generates rendering information for responding to the request. The container deployment system provides the rendering information to the online system, and the online system forwards the rendering information to the client device. Containers deployed by the container deployment system run the packaged applications in an isolated standardized runtime environment by maintaining its own private view of the operating system, file system structure, and network interface.

Although rendering information may be generated through one or more processes on a computing host, this requires each process in the host to have access to resources for rendering each application, and a significant number of such processes can result in an inefficient use of resources and create system failures such as out-of-memory errors in the host. In contrast, the container deployment system generates rendering information in a more reliable manner by deploying containers that have resources dedicated to the subset of web applications associated with the container.

### BRIEF DESCRIPTION OF DRAWINGS

FIG. 1 is a system environment for generating and routing rendering information based on web application containers according to one embodiment.

FIG. 2A illustrates an example process for routing rendering information according to one embodiment. FIG. 2B illustrates an example process for scaling container instances in the example process of FIG. 2A according to one embodiment.

FIG. 3 is a block diagram illustrating components of the online system according to one embodiment.

FIG. 4 is a block diagram illustrating components of the container deployment system according to one embodiment.

FIG. 5 is an example flowchart for routing rendering information according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

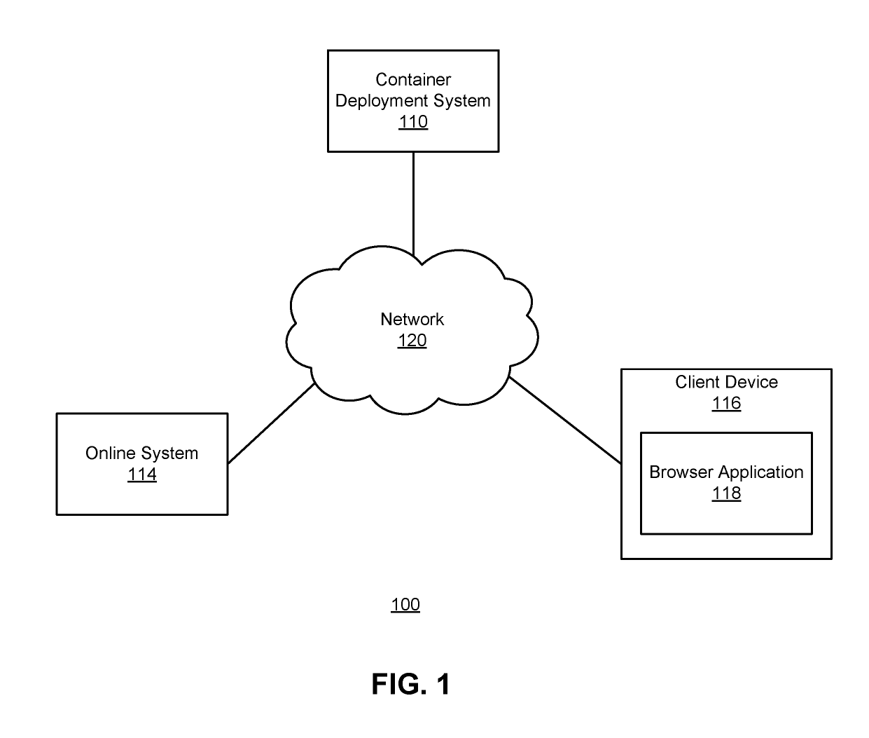

FIG. 1 is a system environment 100 for generating and routing rendering information based on web application containers according to one embodiment. The system environment 100 shown in FIG. 1 comprises one or more client devices 116, a network 120, an online system 114, and the container deployment system 110. In alternative configurations, different and/or additional components may be included in the system environment 100.

The online system 114 is a system for providing various types of online services to users of client devices 116. The online system 114 may be, for example, an Internet service provider, an email provider, a search engine, an online banking site, or a wiki managed by a business, organization, or group. In one embodiment, the online system 114 is an online education system, such as a massive open online course (MOOC) system that provides online courses and curriculums to users of the online system 114 through various components such as video lectures, graded assignments, and the like.

The online system 114 manages and deploys one or more applications for providing online services to users. Specifically, an application may be a client-server software application directed to some functionality, task, or service of the online system 114, in which the client or user interface is run in a client device 116. For example, an online education system may include a user dashboard that allows a user to provide log-in information for the user's account, and displays lectures or courses that the user has most recently accessed. As another example, the online education system may include a course-based application that guides a user through a specific course, allowing the user to watch videos of lectures and submit assignments required for completing the course. The online education system may include many course-based applications that are responsible for providing services and resources for a corresponding online course managed by the online education system. As yet another example, the online education system may include a payment-based application that allows a user to provide payments for access to resources on the online system 114, such as course materials.

In one particular embodiment referred throughout the remainder of the specification, an application is a web application, in which the client is run in a browser application 118 included in the client device 116. However, it is appreciated that in other embodiments, an application can also be a mobile application, in which the client is run as a native application on the client device 116 itself.

An application, in most cases, includes various display elements (e.g., user interface elements) that are displayed on one or more pages on the client device 116. An application may be composed of a single-page, or may span across multiple pages. The display elements visually present the content of the application on the client device 116 in a way specified by the entity managing the application. For example, a video display element may be placed within a dedicated space on the page to present an online lecture video to the user of the client device 116. As another example, an advertisement display element may be placed within a dedicated space on the top portion of the page to present an advertisement. The display elements additionally allow the user to interact with or view other types of information related to the application.

The display elements may include static elements (e.g., decorative banner on the page), but also dynamic elements that can be animated or that can interact with the client (e.g., shopping cart updated based on user input). Generally, a page that the display elements reside on can be represented as code in standard markup language (e.g., HTML) that include the content of the page, components (e.g., JavaScript) for programming additional dynamic elements on the page, and presentation information specifying various presentation properties of the display elements. A client application, such as a browser application, can “render” the code to generate the display elements on the page. Specifically, the browser application of the client device 116 renders code by parsing the text of the code, and interpreting the code to generate display elements according to the specified presentation information in the code.

The presentation properties are characteristics that indicate how the display elements should be displayed on the page. For example, the presentation properties can specify the size and color of individual display elements. As another example, the presentation properties can specify how the display elements should be arranged relative to one another on the page. The presentation properties for a set of display elements can differ depending on the type of client device 116. For example, display elements may be arranged in a different manner within a browser application of a desktop computer than a browser application of a mobile smartphone.

The online system 114 receives requests from client devices 116 to display elements of an application, and provides rendering information that client devices 116 can process to display the response on a page. In addition to display elements, a client request can also include user input data (e.g., login information) to the application, and the response can include a response to the user input data (e.g., validation of login information). In one particular embodiment referred throughout the specification, the rendering information provided by the online system 114 includes standard markup code that already incorporates contents of the response (“server-side rendering”) and is ready-to-be rendered by a client device 116. However, it is appreciated that in other embodiments, the rendering information provided by the online system 114 includes an incomplete version of the standard markup code to render the page, and instead additionally includes components (e.g., JavaScript engine) that generate the remaining code in communication with the online system 114 (“client-side rendering”).

In the case of client-side rendering, the browser application may have to wait until the additional components are downloaded on the client device 116 to generate the remaining code before the code can be rendered to generate the display elements on the page. In the case of server-side rendering, the browser application can proceed to parse and interpret the code included in the rendering information to generate the set of display elements without having to wait for additional components to be downloaded.

The online system 114 generates a set of container images that are stand-alone executable software packages of applications of the online system 114. Each container image may correspond to a subset of one or more applications of the online system 114, and may include only the components required to run the subset of applications. The software in a container image, when executed responsive to a client request, generates rendering information for the subset of applications associated with the container image. The set of container images include components such as code, runtime, libraries, environment variables, and configuration files to run the packaged application software on the container deployment system 110. In one particular embodiment referred throughout the remainder of the specification, each container image corresponds to a version of an application. For example, a container image may correspond to version 1 of Application 2, while another container image may correspond to version 2 of Application 2.

The online system 114 may generate the container images within, for example, a server of the online system 114, and provide the container images to the container deployment system 110. Alternatively, the online system 114 may generate the container images by working with the container deployment system 110. Once they are generated, the container images may already be stored within, for example, a server of the container deployment system 110 without a separate need for the online system 114 to forward the container images to the container deployment system 110. The online system 114 forwards the client request to the container deployment system 110, and receives rendering information generated from the appropriate container image that can be returned to the client device 116.

In one embodiment, the online system 114 specifies a set of resource settings associated with a container image that specify how different types of computational resources are allocated when the software of the container image is run on a computing host. For example, the online system 114 may specify to run software in a container image using high memory capacity. This allows the online system 114 to specify in advance how different types of resources should be allocated for the subset of applications associated with a container image, such that applications can be executed in a computationally efficient manner.

The container deployment system 110 receives client requests from the online system 114, and identifies the appropriate container image associated with the application of the request. The container deployment system 110 deploys the software of the selected container image in a container and generates rendering information for responding to the client request. Containers deployed by the container deployment system 110 run the packaged applications in an isolated standardized runtime environment by maintaining its own private view of the operating system, file system structure, and network interface. In contrast to virtual machines (VM), containers can share a single kernel, and the only information that needs to be in a container image is the executable and its package dependencies, making them less resource-heavy than VMs that include guest operating systems on the host. In one embodiment, the container deployment system 110 is configured to run software in a container image using the set of resource settings associated with the container image. Examples of container platforms include the open-source Docker platform made available by Docker, Inc. and Lima Containers (LXC). In addition, the functions of the container deployment system 110 may be performed by the same entity as the online system 114, or a different entity than the online system 114. For example, the container deployment system 110 may be included in the same server as the online system 114 (or in a server managed or controlled by the online system 114), or may be included in a different server than the online system 114 (or in a server that is not managed or controlled by the online system 114, such as a server controlled by a different or third party entity).

Although rendering information may be generated through one or more processes on a computing host, this requires each process in the host to have access to resources for rendering each application, and a significant number of such processes can result in an inefficient use of resources and create system failures such as out-of-memory errors in the host. Moreover, this does not follow immutable architecture, since the code of these processes often have to be dynamically updated. In contrast, the container deployment system 110 generates rendering information in a more reliable manner by deploying containers that have resources dedicated to the subset of web applications associated with the container. The container deployment system 110 is advantageous in terms of immutable architecture, since the code for containers does not change once they are run.

The container deployment system 110 may run multiple container instances deployed from the same container image, in which each instance runs the subset of applications associated with the container image. For example, the container deployment system 110 may run 3 container instances of version 2 of Application 1, each handling a different set of client requests. In one embodiment, the container deployment system 110 scales the number of container instances based on a scaling policy specified by, for example, an administrator of the online system 114. The scaling policy specifies when and how the number of container instances for a container image are increased or decreased based on, for example, manual settings or changes in client request volume. For example, the container deployment system 110 may automatically generate more container instances associated with version 1 of Application 3 responsive to receiving a sudden spike in client requests for the application. The container deployment system 110 can also monitor various usage states of container instances, and scale the number of container instances as needed.

This way, computational resources for generating rendering information can be scaled at the application-level, in which additional resources are dedicated to the subset of applications that require it. In particular, the environment 100 shown in FIG. 1 can especially be advantageous for MOOC online systems that respond to requests from many client devices (e.g., in the millions) for access to many different types of applications that relate to, for example, different online courses. By generating rendering information through the container deployment system 110, a MOOC online system can automatically and dynamically scale computational resources for each application as it receives an increasing or decreasing number of client requests for the application.

The client device 116 is a computing device capable of receiving user input as well as communicating via the network 120. While a single client device 116 is illustrated in FIG. 1, in practice many client devices 116 may communicate with the systems in environment 100. In one embodiment, a client device 116 is a conventional computer system, such as a desktop or laptop computer. Alternatively, a client device 116 may be a device having computer functionality, such as a personal digital assistant (PDA), a mobile telephone, a smartphone or another suitable device. A client device 116 is configured to communicate via the network 120. In one embodiment, a client device 116 includes a browser application 118 and executes the browser application 118 to interact with the online system 114. For example, a client device 116 executes the browser application 118 to enable interaction between the client device 116 and the online system 114 via the network 120.

The client devices 116 can view or interact with various elements of the applications of the online system 114 through a browser 118. Specifically, a client device 116 sends a request to the online system 114, and receives rendering information that the browser application 118 can process to display elements of the application on a page of the browser 118. The browser 118 renders the markup code based on presentation information included in the rendering information such that display elements of the requested application can be displayed to the user.

The client devices 116, the online system 114, and the container deployment system 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

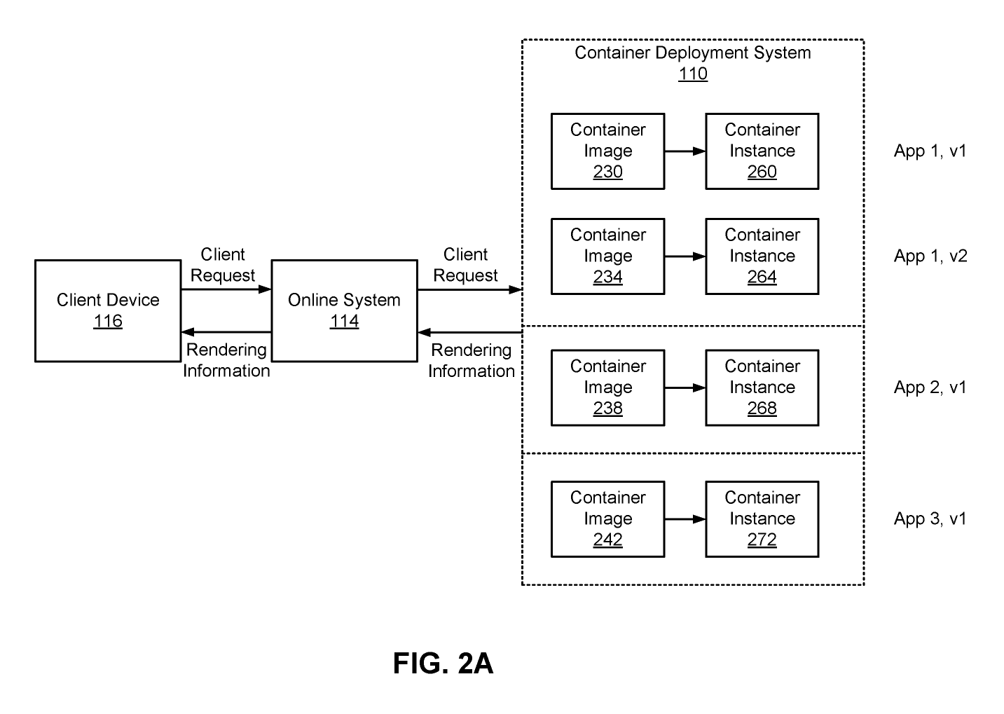

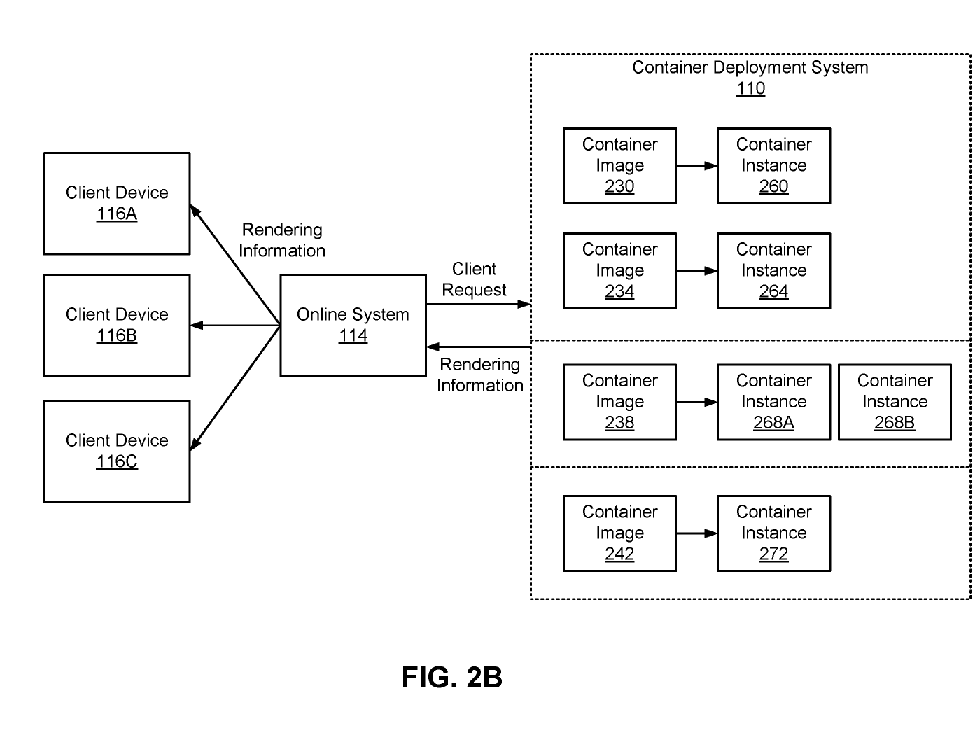

FIG. 2A illustrates an example process for routing rendering information according to one embodiment. In the example shown in FIG. 2A, the container deployment system 110 includes a container image 230 associated with version 1 of Application 1, a container image 234 associated with version 2 of Application 1, a container image 238 associated with version 1 of Application 2, and a container image 242 associated with version 1 of Application 3 of the online system 114. When deployed, software packaged in container image 230 is run on container instance 260, software packaged in container image 234 is run on container instance 264, software packaged in container image 238 is run on container instance 268, and software packaged in container image 242 is run on container instance 272.

A client device 116 requests, to the online system 114, rendering information for version 1 of Application 2. The online system 114 forwards the request to the container deployment system 110, such that the container deployment system 110 can identify the appropriate container image 238 associated with the application of the request. The container deployment system 110 deploys the application software packaged in container image 238 in container instance 268 to generate rendering information for the request. The rendering information is provided to the online system 114, which provides it to the client device 116 such that the application response can be displayed to the user.

FIG. 2B illustrates an example process for scaling container instances in the example process of FIG. 2A according to one embodiment. The example shown in FIG. 2B is similar to the example shown in FIG. 2A, except that a higher volume of clients request, to the online system 114, rendering information for version 1 of Application 2. Specifically, client devices 116A, 116B, 116C request rendering information to the online system 114. The online system 114 forwards the requests to the container deployment system 110. Since the number of client requests has spiked, the container deployment system 110 now deploys two container instances 268A, 268B to handle the increase in volume for version 1 of Application 2. As described previously, by creating and deleting container instances as needed, the container deployment system 110 can easily provide application-level scaling for generating rendering information responsive to client requests.

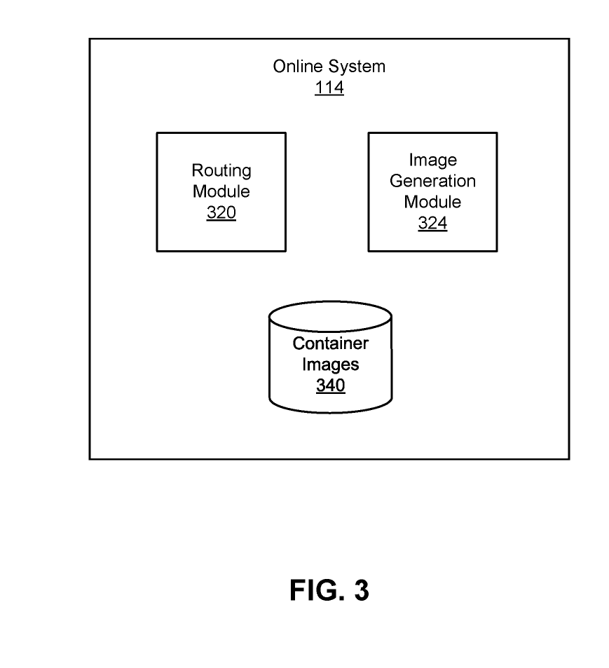

FIG. 3 is a block diagram illustrating components of the online system 114 according to one embodiment. The online system 114 shown in FIG. 3 includes a routing module 320 and an image generation module 324. The online system 114 also includes container images 340. In other embodiments, the online system 114 may include additional, fewer, or different components for various applications. Conventional components such as network interfaces, security functions, load balancers, failover servers, management and network operations consoles, and the like are not shown so as to not obscure the details of the system architecture.

The routing module 320 routes client requests to the container deployment system 110. The routed requests include application information describing the application of the request and optionally, the version of the application. In one embodiment, the routing module 320 routes requests to the container deployment system 110 using a descriptive URL that hits the endpoint of the container deployment system 110. The application information is included in the descriptive URL. For example, the routing module 320 may route a client request for version 3 of Application 2 using a URL address “app2.v3.render.organization.org/my/endpoint.” The routing module 320 also receives rendering information associated with the request, and forwards the rendering information to the client device 116 of the request.

The image generation module 324 generates and manages a set of container images 340 each associated with a subset of applications of the online system 114. The set of container images are stored in the container images data store 340. In one embodiment, a container image 340 is associated with a set of application parameters indicating which subset of applications and/or versions of the applications are contained in the packaged software. In one embodiment, the container image 340 is also associated with a set of resource parameters indicating how different types of resources should be allocated when running the software of the image 340 in a container instance. In one instance, the resource parameters include a memory threshold indicating how much memory of the computing host can be allocated to an instance of the container image 340. In another instance, the resource parameters include a CPU threshold indicating how many CPU units of the computing host can be allocated to an instance of the container image 340. The set of container images 340 are provided to the container deployment system 110.

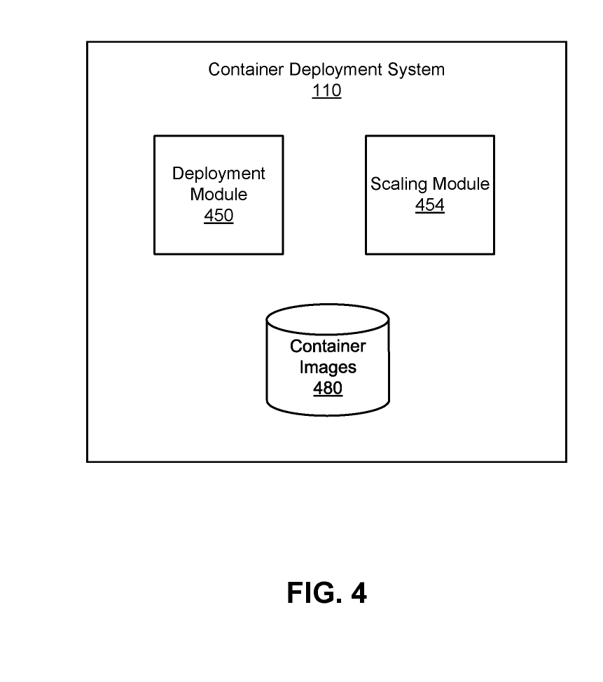

FIG. 4 is a block diagram illustrating components of the container deployment system 110 according to one embodiment. The container deployment system 110 includes a deployment module 450 and a scaling module 454. The container deployment system 110 also includes container images 480 received from the online system 114. In other embodiments, the container deployment system 110 may include additional, fewer, or different components for various applications. Conventional components such as network interfaces, security functions, load balancers, failover servers, management and network operations consoles, and the like are not shown so as to not obscure the details of the system architecture.

The deployment module 450 instantiates and manages a set of container instances based on the set of container images 480 received from the online system 114. The deployment module 450 deploys the set of container instances based on the container images 480, and any resource parameters specified in conjunction with the container images 480. Specifically, the deployment module 450 receives a routed request from the online system 114, and identifies a container instance associated with the request based on the application information included in the request. The deployment module 450 provides the rendering information generated by the container instance to the online system 114. The deployment module 450 can perform additional load balancing functions as required by the container deployment system 110.

The scaling module 454 determines when and how to scale container instances based on a scaling policy. The scaling module 454 monitors various scaling factors, such as the volume of client requests for the subset of applications associated per container image, the volume of routed requests received by the container deployment system 110, the number of running container instances per container image, and resource usage metrics of running container instances that may trigger the scaling module 454 to request fewer or more container instances to the deployment module 450. For example, resource usage metrics may include memory usage, CPU unit usage, and/or network bandwidth usage of a container instance.

The scaling module 454 may request the deployment module 450 to scale the number of container instances according to the set of rules specified in the scaling policy with respect to the scaling factors. For example, the scaling module 454 may request the deployment module 450 to scale up the number of container instances for a container image if the number of routed requests received for the application of the container image is above a scaling threshold. As another example, the scaling module 454 may request the deployment module 450 to scale down the number of container instances for a container image if the number of routed requests is below a scaling threshold. As another example, the scaling module 454 may request the deployment module 450 to instantiate additional container instances for version 1 of Application 2 if the existing container instances of the application are running with a CPU usage rate above 90% for a predetermined amount of time. As another example, the scaling module 454 may request the deployment module 450 to eliminate container instances for version 2 of Application 1 if the existing container instances of the application are running with a memory usage below 15% for a predetermined amount of time.

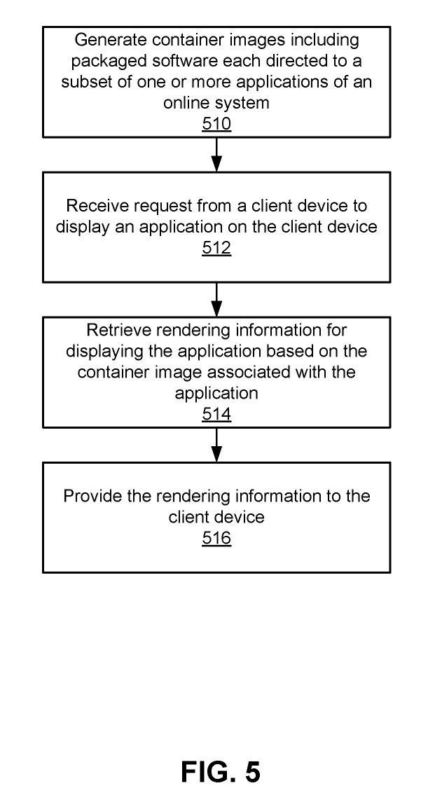

FIG. 5 is an example flowchart for routing rendering information according to one embodiment. The online system generates 510 one or more container images each including packaged software directed to a subset of one or more applications of the online system. The online system receives 512 requests from a client device to display an application on the client device 512. The online system retrieves 514 rendering information for displaying the application on the client device based on the container image associated with the application. The rendering information is generated by running the software of the container image in a container instance. The online system provides 516 the rendering information to the client device.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method, comprising:
generating one or more container images, each container image including packaged software directed to a subset of one or more applications of an online system;
receiving a request from a client device to display contents of an application of the online system on a page within the client device;
retrieving rendering information for displaying the application on the client device, wherein the rendering information includes information for displaying a set of display elements that visually present the contents of the application on the client device, and wherein the rendering information is generated by running the packaged software of a container image that is directed to the application in a container instance deployed from the container image; and
providing the rendering information to the client device to allow the client device to display the display elements of the application on the client device.

2. The method of claim 1, wherein the online system is an online education system, and the contents of the application include educational information related to online courses managed by the online education system.

3. The method of claim 1, wherein the rendering information for the client device includes code that can be parsed by a client application on the client device to generate the set of display elements on the page.

4. The method of claim 1, wherein each container image is directed a particular version of an application of the online system, and wherein the request further indicates a version of the requested application.

5. The method of claim 1, wherein the container instance is deployed in a first server, and the rendering information is retrieved by a second server separate from the first server.

6. The method of claim 1, wherein the container instance is deployed in a server, and the rendering information is retrieved by the same server.

7. The method of claim 1, further comprising:
routing the request to a container deployment system that deploys the container instance to generate the rendering information for the client device, and
receiving the rendering information from the container deployment system.

8. The method of claim 7, further comprising:
receiving a plurality of requests to display the contents of the application on a plurality of client devices,
routing the plurality of requests to the container deployment system, wherein a number of the routed requests exceeds a scaling threshold, and
retrieving rendering information for the plurality of client devices from the container deployment system, wherein the rendering information for the plurality of client devices is generated by additionally deploying a plurality of container instances responsive to routing the plurality of requests that exceed the scaling threshold.

9. The method of claim 7, wherein the request is routed using a descriptive URL address that indicates the application requested by the client device.

10. The method of claim 1, wherein a container image is associated with a set of resource parameters indicating how computing resources should be allocated when running the software of the container image.

11. A non-transitory computer-readable storage medium storing executable computer program instructions, the instructions comprising instructions for:
generating one or more container images, each container image including packaged software directed to a subset of one or more applications of an online system;
receiving a request from a client device to display contents of an application of the online system on a page within the client device;
retrieving rendering information for displaying the application on the client device, wherein the rendering information includes information for displaying a set of display elements that visually present the contents of the application on the client device, and wherein the rendering information is generated by running the packaged software of a container image that is directed to the application in a container instance deployed from the container image; and
providing the rendering information to the client device to allow the client device to display the display elements of the application on the client device.

12. The non-transitory computer-readable storage medium of claim 11, wherein the online system is an online education system, and the contents of the application include educational information related to online courses managed by the online education system.

13. The non-transitory computer-readable storage medium of claim 11, wherein the rendering information for the client device includes code that can be parsed by a client application on the client device to generate the set of display elements on the page.

14. The non-transitory computer-readable storage medium of claim 11, wherein each container image is directed a particular version of an application of the online system, and wherein the request further indicates a version of the requested application.

15. The non-transitory computer-readable storage medium of claim 11, wherein the container instance is deployed in a first server, and the rendering information is retrieved by a second server separate from the first server.

16. The non-transitory computer-readable storage medium of claim 11, wherein the container instance is deployed in a server, and the rendering information is retrieved by the same server.

17. The non-transitory computer-readable storage medium of claim 11, wherein the instructions further comprise:
routing the request to a container deployment system that deploys the container instance to generate the rendering information for the client device, and
receiving the rendering information from the container deployment system.

18. The non-transitory computer-readable storage medium of claim 17, further comprising:
receiving a plurality of requests to display the contents of the application on a plurality of client devices,
routing the plurality of requests to the container deployment system, wherein a number of the routed requests exceeds a scaling threshold, and
retrieving rendering information for the plurality of client devices from the container deployment system, wherein the rendering information for the plurality of client devices is generated by additionally deploying a plurality of container instances responsive to routing the plurality of requests that exceed the scaling threshold.

19. The non-transitory computer-readable storage medium of claim 17, wherein the request is routed using a descriptive URL address that indicates the application requested by the client device.

20. A server comprising:
a processor for executing computer program instructions; and
a non-transitory computer-readable storage medium storing computer program instructions executable to perform steps comprising:
generating one or more container images, each container image including packaged software directed to a subset of one or more applications of an online system;
receiving a request from a client device to display contents of an application of the online system on a page within the client device;
retrieving rendering information for displaying the application on the client device, wherein the rendering information includes information for displaying a set of display elements that visually present the contents of the application on the client device, and wherein the rendering information is generated by running the packaged software of a container image that is directed to the application in a container instance deployed from the container image; and
providing the rendering information to the client device to allow the client device to display the display elements of the application on the client device.
